(19) United States
(12) Patent Application Publication
(10) Pub. No.: US 2013/0314952 A1
(43) Pub. Date: Nov. 28, 2013

(54) SINGLE-PHASE REACTOR POWER SAVING DEVICE

(71) Applicants: YI JU CHUNG, HSINCHU COUNTY 302 (TW); CHIA HSIEN PU, HSINCHU COUNTY 302 (TW)

(72) Inventors: YI JU CHUNG, HSINCHU COUNTY 302 (TW); CHIA HSIEN PU, HSINCHU COUNTY 302 (TW)

(73) Assignee: RONG SHIN JONG CO., LTD., HSINCHU COUNTY 302 (TW)

(21) Appl. No.: 13/603,727

(22) Filed: Sep. 5, 2012

(30) Foreign Application Priority Data
May 24, 2012 (TW) 101209885

(51) Int. Cl. H02M 5/458; H02M 7/06

(52) U.S. Cl. 363/37; 363/126

(57) ABSTRACT

A single-phase reactor power saving device, used to receive an AC power supply, and comprising: a first capacitor, connected electrically to said AC power supply, to store electric energy; a first and a second reactor, connected electrically to said first capacitor, to output first AC self-induced energy, and second AC self-induced energy; a center-tapped circuit, connected electrically to said first reactor and said second reactor, to convert currents of said first AC self-induced energy and said second AC self-induced energy into a DC current; a second capacitor, connected electrically to said center-tapped circuit, to store energy of said DC current; and a first DC reactor and a second DC reactor, connected electrically to said center-tapped circuit, to generate and output respectively currents of first DC self-induced energy and second DC self-induced energy to said load, to raise power saving efficiency and quality of power supply.

### BACKGROUND OF THE INVENTION

1. Field of the Invention

The present invention relates to a power saving device, and in particular to a single-phase reactor power saving device.

2. The Prior Arts

In recent years, the rapid progress and development of science and technology has brought about accelerated economic growth and raise of our standard of living. For the convenience of our daily life, the number of electrical appliances used in ordinary households has increased, so the energy consumption and carbon dioxide produced have increased. Also, in the Industries, the demand for more electricity is rising rapidly, thus bringing about severe energy crisis. The shortage of energy caused by energy crisis could cause decline and slow-down of the economy. For this reason, many countries of the world have engaged in developing green energy. Therefore, presently, the developments of clean green energy and power saving devices have become two important subjects for the green energy Industry worldwide.

Up until recently, in order to relieve the energy crisis, quite a lot of energy saving devices are available on the market. For which, power supply is designed to be turned-on and turned-off in a predetermined time to save power consumption. When an electric device is not in use, the user has only to shut-off the main switch, to cut it off from the outside power supply, in achieving the purpose of power saving. However, in this approach of power saving, switch has to be turned-on and turned-off manually, thus it can hardly achieve real power saving efficiently.

Therefore, presently, the design and performance of power saving device of the prior art is not quite satisfactory, and it has much room for improvements.

### SUMMARY OF THE INVENTION

In view of the problems and shortcomings of the prior art, the present invention provides a single-phase reactor power saving device, that can be applied for all the resistive, capacitive, and inductive loads of the industrial equipments and household appliances to save power, to solve the drawbacks of the prior art.

A major objective of the present invention is to provide a single-phase reactor power saving device, that is capable of producing magneto-electric effect to achieve power saving, reduce power consumption of load, and raise the overall quality and performance of power supply.

Another objective of the present invention is to provide a single-phase reactor power saving device, wherein a rectifier circuit is connected electrically to a single-phase transformer, to rectify a current of third AC self-induced energy into a DC current. Therefore, it can reduce the capacity required for the power input device. Meanwhile, it can reduce the compensation power for circuit current, and enhance optimization of reactor rectification.

A yet another objective of the present invention is to provide a single-phase reactor power saving device, for which the addition of a capacitor could offset part of the reactive power (KVAR), raise the active power (KW), increase power factor (PF), and reduce the total power consumption (KVA), so that it can be used widely in the various loads of the industrial equipments and household appliances to save power. In addition, the single-phase reactor power saving device of the present invention is able to meet the power factor specifications of Taiwan Power Company, that its power factor not lower than 80% of the current lagging power factor.

A further objective of the present invention is to provide a single-phase reactor power saving device, such that through the addition of as bridge rectifier circuit, the single-phase reactor power saving device is able to receive and convert a current of DC self-induced energy into current. Therefore, it can be used to drive DC load as well as AC load. Also, in addition to the newly added bridge rectifier circuit, a reactor having ferrite inductance is selected, to enable conversion to the maximum DC current. In such an approach, the present invention integrates power supply systems of various functions, such as active power filter (APF) and power factor corrector (PFC), to provide DC driving power, and improve power supply quality to achieve power saving.

A yet another objective of the present invention is to provide a single-phase reactor power saving device, to reduce the line impedance, raise overall quality and effectiveness. Since the circuit current is decreased, thus the voltage drop is reduced, so it can provide more stable power of good quality, reduce equipment cost, and prolong its service life. Moreover, it can improve voltage conversion rate, and provide power to the loads of various equipment. When the single-phase reactor power saving device is placed close to the main switch, its power supply efficiency is increased. When it is used in a switch of a power distribution panel to match with the load, the power factor of the entire power supply is raised.

In order to achieve the above-mentioned objective, the present invention provides a single-phase reactor poster saving device, that is used to receive AC power supply, and is connected electrically to the load. The single-phase reactor power saving device includes at least: a first capacitor, a first reactor, a second reactor, a center-tapped circuit, a second capacitor, and a first DC reactor and a second DC reactor. Wherein, the first capacitor is connected electrically to an AC power supply, to store electric energy. The first reactor is connected electrically to the first capacitor, to receive and convert the electric energy into a first AC self-induced energy. The second reactor is connected electrically to the first capacitor, to receive and convert the electric energy into a second AC self-induced energy. The center-tapped circuit is connected electrically to the first reactor and the second reactor, to receive and convert the first AC self-induced energy and second AC self-induced energy into energy of a DC current. The second capacitor is connected electrically to the center-tapped circuit to store energy of the DC current. The first DC reactor and the second DC reactor are connected electrically to the center-tapped circuit, to receive the DC current, and output respectively the first DC self-induced energy and second DC self-induced energy to the load.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a circuit diagram of a single-phase reactor power saving device according to an embodiment of the present invention;

FIG. 2 is a circuit diagram of a single-phase reactor power saving device with an added circuit breaker according to an embodiment of the present invention; and

FIG. 3 is a circuit diagram of a single-phase reactor power saving device with an added bridge rectifier circuit according to an embodiment of the present invention.

### DETAILED DESCRIPTION OF THE PREFERRED EMBODIMENT

The purpose, construction, features, functions and advantages of the present in invention can be appreciated and understood more thoroughly through the following detailed description with reference to the attached drawings. And, in the following, various embodiments are described in explaining the technical characteristics of the present invention.

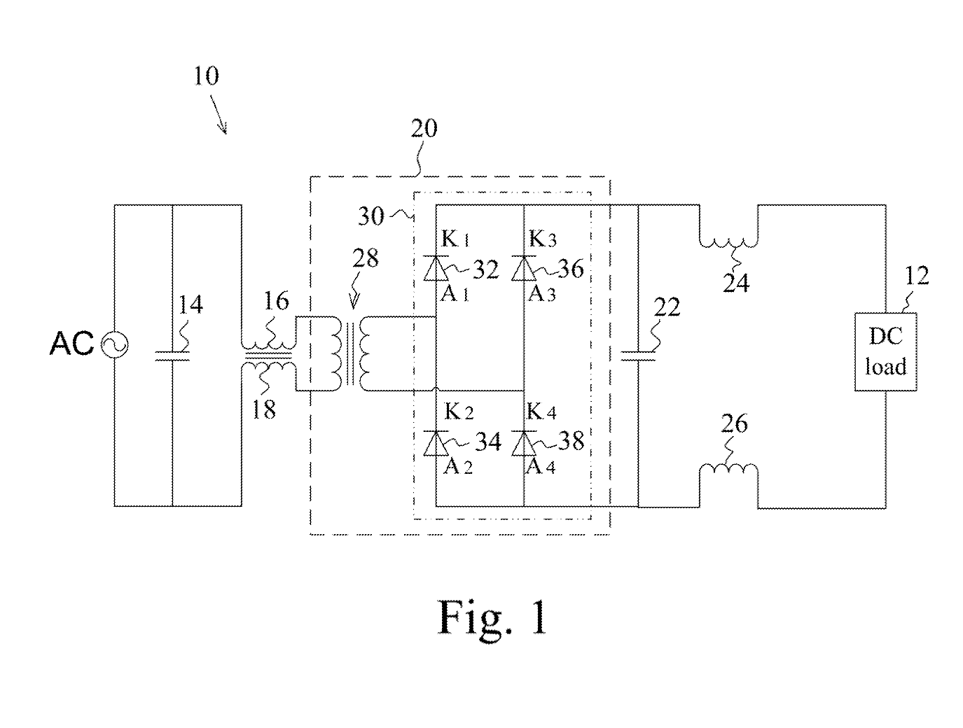

In the following, an embodiment is described to explain the principle of operation of the present invention. Firstly, refer to FIG. 1 for a circuit diagram of a single-phase reactor power saving device according to in embodiment of the present invention. As shown in FIG. 1, the single-phase reactor power saving device 10 receives an AC power supply and is connected electrically to a DC load 12, such that the AC power supply carries with it electric energy. The single-phase reactor power saving device 10 includes at least: a first capacitor 14, a first reactor 16, a second reactor 18, a center-tapped circuit 20, a second capacitor 22, and a first DC reactor 24 and a second DC reactor 26. Wherein, the first capacitor 14 can be a power capacitor, connected electrically to an AC power supply to store electric energy. The first reactor 16 and the second reactor 18 can be power reactors, connected electrically to the first capacitor 14 to receive and convert the electric energy into a first AC self-induced energy and a second AC self-induced energy. The center-tapped circuit 20 is connected electrically to the first reactor 16 and the second reactor 18, to receive and convert the first AC self-induced energy and second AC self-induced energy into energy of a DC current. The second capacitor 22 can also be as power capacitor, connected electrically to the center-tapped circuit 20 to store energy of the DC current. The first DC reactor 24 and the second DC reactor 26 are connected electrically to the center-tapped circuit 20, to receive DC current, and then generate and output respectively the first DC self-induced energy and second DC self-induced energy to the DC load 12.

As mentioned above, the DC load 12 can be a resistant load, an inductive load, or a capacitive load, and is connected electrically to the first DC reactor 24 and the second DC reactor 26 to form a loop. The DC load 12 is able to receive the first DC self-induced energy and the second DC self-induced energy.

The center-tapped circuit 20 is provided with a single-phase transformer 28, connected electrically to the first reactor 16 and the second reactor 18, to receive the first AC self-induced energy and the second AC self-induced energy, and convert them to a third AC self-induced energy. The rectifier circuit 30 is connected electrically to the single-phase transformer 28, to rectify the current of the third AC self-induced energy into a DC current.

The single-phase transformer 28 is provided with an iron core and a coil, such that the iron core is made of a silicon steel plate. Also, the first reactor 16, the second reactor 18, the first DC reactor 24 and the second DC reactor 26 are each provided with an iron core and a coil, such that the iron core is made of a silicon steel plate, to increase its resistance, reduce its coercive force, and improve its magnetic stability, so as to raise its saturation density of magnetic flux.

As mentioned earlier, the first reactor 16, the second reactor 18 are high power reactors, and that are the passive electronic elements capable of storing electrical energy in an AC self-induced energy approach. When a current having an electrical field passes through, AC self-induced energy is generated in a direction to the right of the current. The first reactor 16, the second reactor 18, the first DC reactor 24 and the second DC reactor 26 can be a wire-winding inductor, a stack-layer inductor, a thin-film inductor, or a ferrite inductor. Wherein, when ferrite inductor is selected to use for the first reactor 16, the second reactor 18, the first DC reactor 24, and the second DC reactor 26, it can achieve maximum conversion of DC current.

The rectifier circuit 30 includes: a first diode 32, a second diode 34, a third diode 36, and a fourth diode 38, and they are all high power diodes. The first diode 32 is provided with a first anode A1, and a first cathode K1, with the first anode A1 connected electrically to a single-phase transformer 28. The second diode 34 is provided with a second anode A2, and a second cathode K2, with the second cathode K2 connected electrically to the first anode A1 and the single-phase transformer 28. The third diode 36 is provided with a third anode A3 and a third cathode K3, with the third cathode K3 connected electrically to the first cathode K1 and the second capacitor 22. The fourth diode 38 is provided with a fourth anode A4 and a fourth cathode K4, with the fourth anode A4 connected electrically to the second anode A2 and the second capacitor 22, and with the fourth cathode K4 connected electrically to the third anode A3 and the single-phase transformer 28.

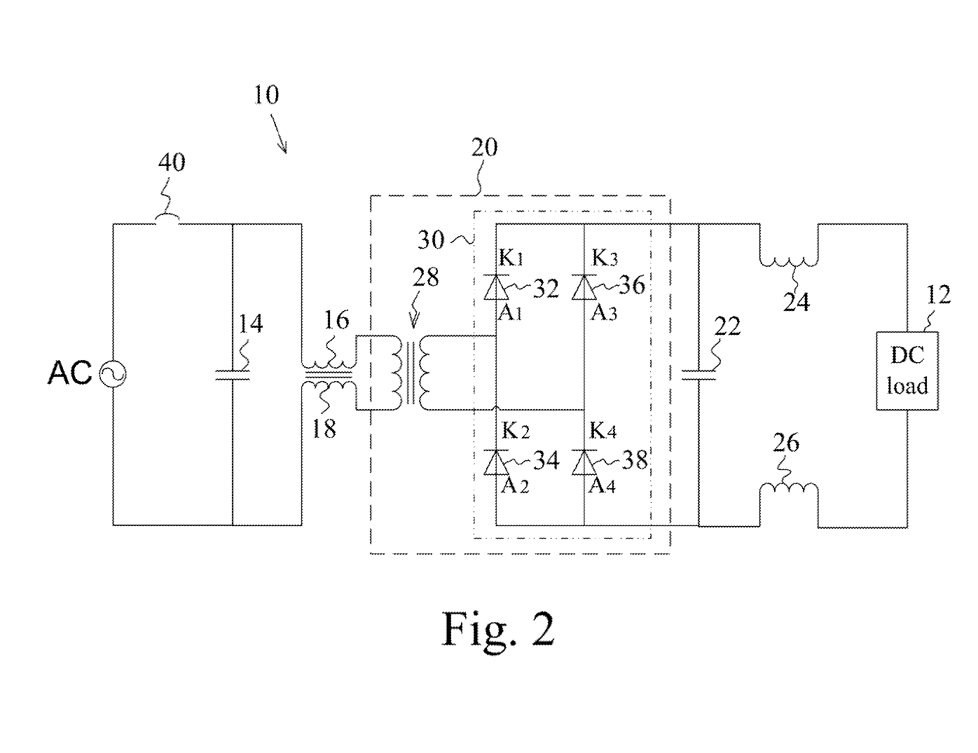

Then, refer to FIG. 2 for a circuit diagram of a single-phase reactor power saving device with an added circuit breaker according to an embodiment of the present invention. As shown in FIG. 2, a circuit breaker 40 is connected electrically between an AC power supply and the first capacitor 14. Wherein, the circuit breaker 40 is an over-current protection device, used in a main switch or power distribution control switch in a household or industrial cabling, to protect effectively the load. Its main purpose is to prevent short circuit and overload. Also, for the protection of the industrial equipments, the circuit breaker is designated as an important protection device.

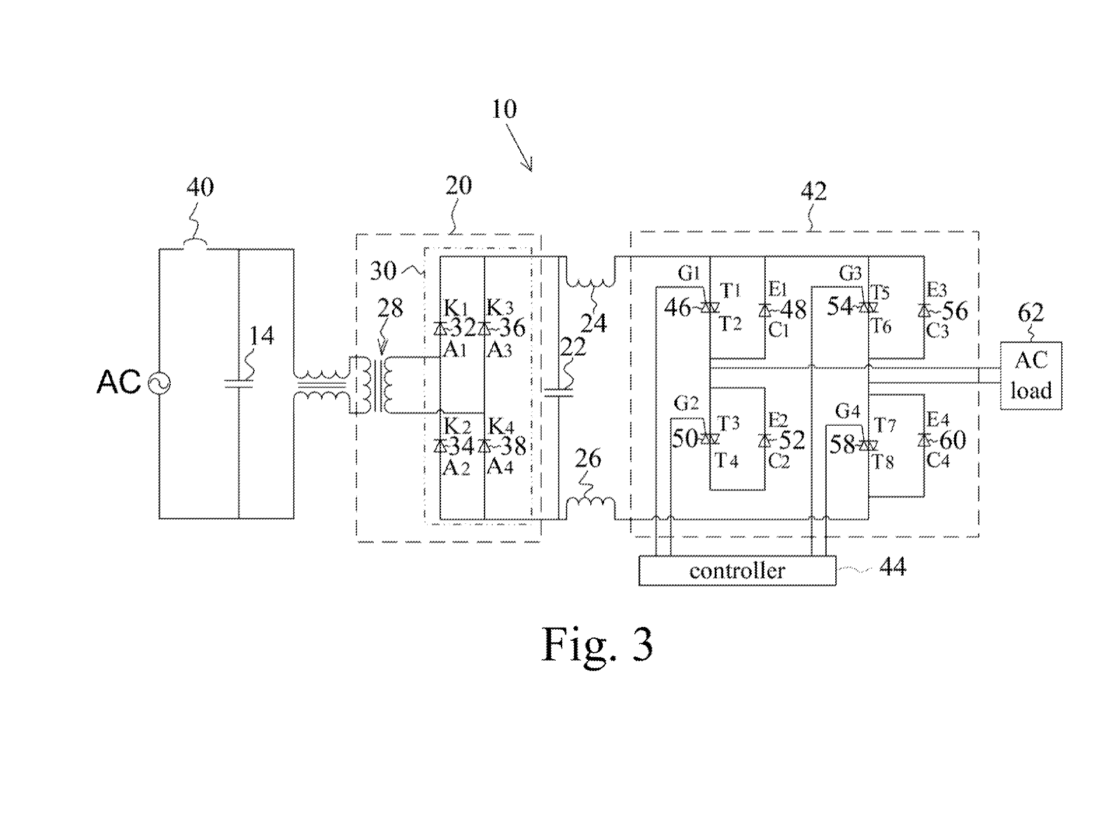

Subsequently, refer to FIG. 3 for a circuit diagram of a single-phase reactor power saving device with an added bridge rectifier circuit according to an embodiment of the present invention. As shown in FIG. 3, the newly added bridge rectifier circuit 42 is connected electrically to the first DC reactor 24 and the second DC reactor 26, to receive and convert current of the first DC self-induced energy and the second DC self-induced energy into an AC current. In addition, a controller 44 is connected electrically to the bridge rectifier circuit 42 to control the conditions of the bridge rectifier circuit 42.

In the descriptions mentioned above, the bridge rectifier circuit 42 includes: a first bi-directional Silicon Controlled Rectifier (SCR) 46 to a fourth bi-directional Silicon Controlled Rectifier (SCR) 58; and a first Insulated Gate Bipolar Transistor (IGBT) 48 to a fourth Insulated Gate Bipolar Transistor (IGBT) 60.

Wherein, the first bi-directional Silicon Controlled Rectifier (SCR) 46 is provided with a first terminal T1, a second terminal T2, and a first control gate G1. The first insulated Gate Bipolar Transistor (IGBT) 48 is provided with a first emitter E1 and a first collector C1, with the first emitter E1 connected electrically to the first terminal T1, and the first collector C1 connected electrically to the second terminal T2. The second bi-directional Silicon Controlled Rectifier (SCR) 50 is provided with a third terminal T3, as fourth terminal T4, and a second control gate G2, with the third terminal T3 connected electrically to the second terminal T2. The second Insulated Gate Bipolar Transistor (IGBT) 52 is provided with a second emitter E2 and a second collector C2, with the second emitter E2 is connected electrically to the third terminal T3, the second collector C2 connected electrically to the fourth terminal T4, and the second emitter E2 connected electrically to the first collector C1.

The third bi-directional Silicon Controlled Rectifier (SCR) 54 is provided with a fifth terminal T5, a sixth terminal T6, and as third control gate G3. The third Insulated Gate Bipolar Transistor (IGBT) 56 is provided with a third emitter E3 and a third collector C3, with the third emitter E3 connected electrically to the fifth terminal T5, and the third collector C3 connected electrically to the sixth terminal T6. The fourth bi-directional Silicon Controlled Rectifier (SCR) 58 is provided with a seventh terminal T7, an eighth terminal T8, and a fourth control gate G4, with the seventh terminal T7 connected electrically to the sixth terminal T6. The fourth Insulated Gate Bipolar Transistor (IGBT) 60 is provided with a fourth emitter E4 and a fourth collector C4, with the fourth emitter E4 connected electrically to the seventh terminal T7, the fourth collector C4 connected electrically to the eighth terminal T8, and the fourth emitter E4 connected electrically to the third collector C3. Also, the first control gate G1, the second control gate G2, the third control gate G3, and the fourth control gate G4 are all connected electrically to the controller 44.

In addition, an AC load 62 is provided, which can be a resistive load, an inductive load, or a capacitive load, and is connected electrically to the second terminal T2 and the sixth terminal T6 to form a loop, such that the AC load 62 is used to receive AC current.

When the single-phase reactor power saving device 10 is applied through adding a bridge rectifier circuit 42, the single-phase reactor power saving device 10 can be connected to a load, such as an AC load 62 of an AC electric motor. The AC load 62 can be a resistive load, an inductive load, or a capacitive load. Wherein, the resistive load is for example, an incandescent light, or an electric-heat filament; the inductive load is for example an electric-magnetic equipment, such as an AC motor, a single-phase transformer, or an inductor and the capacitive load is for example a capacitor.

Based on the technical characteristics as disclosed in FIGS. 1, 2, and 3, the single-phase reactor power saving device 10 is indeed capable of saving power. It can further decrease power consumption of the load, lower the capacity required for the power input equipment of the load. Meanwhile, it can reduce the compensation power for the circuit current, and enhance the optimization of the reactor rectification. Moreover, it can lower line impedance, raise the overall quality and performance of the power supply. Since the circuit current is decreased, thus the voltage drop is reduced, so it can provide more stable power, reduce equipment cost, and prolong service life. When the single-phase reactor power saving device is placed close to the main switch, it power supply efficiency is raised. In case it is used in a switch of a power distribution panel to match with the load, then its voltage conversion rate is improved, and the power factor of the entire power supply is raised. Most of the power monitoring system is equipped with an automatic control power factor regulator. The single-phase reactor power saving device 10 of the present invention is able to meet the power factor specifications of Taiwan Power Company, that its power factor not lower than 80% of current lagging power factor.

In case the single-phase reactor power saving device 10 is added with a first capacitor 14 and a second capacitor 22, then it can offset part of the reactive power (KVAR), raise the active power (KW), increase power factor (PF), and reduce the total power consumption (KVA), so that it can be used widely in various industrial equipments and household appliances to save power.

When the load is an AC load 62 of an induction motor, an air gap exists between the stator and the rotor of the induction motor, to avoid their being blocked by the friction caused by difference of rotation speeds. For that will generate excitation current after the load is connected, to reduce the power factor. In this condition, it is even more suitable to use the single-phase reactor power saving device 10 of the present invention, to integrate power supply systems of various functions, such as active power filter (APF) and power factor corrector (PFC), to provide DC driving power, and improve power supply quality to achieve power saving.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A single-phase reactor power saving device, used to receive an AC power supply, and is connected electrically to a load, said AC power supply carries with it electric energy, comprising
a first capacitor, connected electrically to said AC power supply, to store said electric energy;
a first reactor, connected electrically to said first capacitor, to receive and convert said electric energy into first AC self-induced energy;
a second reactor, connected electrically to said first capacitor, to receive and convert said electric energy into second AC self-induced energy;
a center-tapped circuit, electrically connected to said first reactor and said second reactor, to receive and convert currents of said first AC self-induced energy and said second AC self-induced energy into a DC current;
a second capacitor, connected electrically to center-tapped circuit, to store energy of said DC current; and
a first DC reactor and a second DC reactor, connected electrically to said center-tapped circuit, to receive said DC current, and generate and output respectively a current of said first DC self-induced energy and a current of said second DC self-induced energy to said load.

2. The single-phase reactor power saving device as claimed in claim 1, wherein said load is a DC load, connected electrically to said first DC reactor and said second DC reactor to form a loop, said DC load receives currents of said first DC self-induced energy and said second DC self-induced energy.

3. The single-phase reactor power saving device as claimed in claim 2, wherein said DC load is a resistive load, an inductive load, or an capacitive load.

4. The single-phase reactor power saving device as claimed in claim 1, wherein said center-tapped circuit comprises:
a single-phase transformer, connected electrically to said first reactor and said second reactor, to receive said first AC self-induced energy and said second AC self-induced energy, and convert them into third AC self-induced energy; and
a rectifier circuit, connected electrically to said single-phase transformer, to rectifier a current of said third AC self-induced energy into a DC current.

5. The single-phase reactor power saving device as claimed in claim 4, wherein said rectifier circuit includes:
a first diode, provided with a first anode and a first cathode, said first anode is connected electrically to said single-phase transformer;
a second diode, provided with a second anode and a second cathode, said second cathode is connected electrically to said first anode and said single-phase transformer;
a third diode, provided with a third anode and a third cathode, said third cathode is connected electrically to said first cathode and said second capacitor; and
a fourth diode, provided with a fourth anode and a fourth cathode, said fourth anode is connected electrically to said second anode and said second capacitor, and said fourth cathode is connected electrically to said third anode and said single-phase transformer.

6. The single-phase reactor power saving device as claimed in claim 4, wherein said single-phase transformer is provided with an iron core and a coil, said iron core is made of a silicon steel plate.

7. The single-phase reactor power saving device as claimed in claim 1, wherein said first capacitor and said second capacitor are power capacitors.

8. The single-phase reactor power saving device as claimed in claim 1, wherein said first reactor and said second reactor are high power reactors, and said first reactor and said second reactor are each provided with an iron core and a coil, said iron core is made of said silicon steel plate.

9. The single-phase reactor power saving device as claimed in claim 8, wherein said first reactor, said second reactor, said first DC reactor, said second DC reactor are each a wire-winding inductor, a stack-layer inductor, a thin-film inductor, or a fern inductor.

10. The single-phase reactor power saving device as claimed in claim 1, further comprising: a circuit breaker, connected electrically to said AC power supply and said first capacitor.

11. The single-phase reactor power saving device as claimed in claim 1, further comprising: a bridge rectifier circuit, connected electrically to said first DC reactor and said second DC rector, to receive and convert a current of said first DC self-induced energy and a current of said second DC self-induced energy into an AC current; and a controller, connected electrically to said bridge rectifier circuit, to control conditions of said bridge rectifier circuit.

12. The single-phase reactor power saving device as claimed in claim 11, wherein said bridge rectifier circuit includes:
a first bi-directional Silicon Controlled Rectifier (SCR), provided with a first terminal, a second terminal, and a first control gate;
a first Insulated Gate Bipolar Transistor (IGBT), provided with a first emitter and a first collector, with said first emitter connected electrically to said first terminal, and said first collector connected electrically to said second terminal;
a second bi-directional Silicon Controlled Rectifier (SCR), provided with a third terminal, a fourth terminal, and a second control gate, with said third terminal connected electrically to said second terminal;
a second Insulated Gate Bipolar Transistor (IGBT), provided with a second emitter and a second collector, with said second emitter connected electrically to said third terminal, said second collector connected electrically to said fourth terminal, and said second emitter is connected electrically to said first collector;
a third bi-directional Silicon Controlled Rectifier (SCR), provided with a fifth terminal, a sixth terminal, and a third control gate;
a third Insulated Gate Bipolar Transistor (IGBT), provided with a third emitter and as third collector, with said third emitter connected electrically to said fifth terminal, and said third collector connected electrically to said sixth terminal;
a fourth bi-directional Silicon Controlled Rectifier (SCR), provided with a seventh terminal, an eighth terminal, and a fourth control gate, with said seventh terminal connected electrically to said sixth terminal; and
a fourth insulated Gate Bipolar Transistor (IGBT), provided with a fourth emitter and a fourth collector, with said fourth emitter connected electrically to said seventh terminal, and said fourth collector connected electrically to said eighth terminal, said fourth emitter connected electrically to said third collector, and said first control gate, said second control gate, said third control gate, and said fourth control gate connected electrically to said controller.

13. The single-phase reactor power saving device as claimed in claim 12, wherein said load is an AC load, connected electrically to said second terminal and said sixth terminal to form a loop, said AC load receives said AC current.

14. The single-phase reactor power saving device as claimed claim 13, wherein said AC load is a resistive load, an inductive load, or a capacitive load.
